(19) United States
(12) Patent Application Publication
(10) Pub. No.: US 2025/0276384 A1
(43) Pub. Date: Sep. 4, 2025

(54) MASS AND HEAT FLOW IN ADDITIVE MANUFACTURING SYSTEMS WITH MACHINE LEARNING CONTROL

(71) Applicants: Rolls-Royce Corporation, Indianapolis, IN (US); Rolls-Royce plc, London (GB)

(72) Inventors: Scott Nelson, Indianapolis, IN (US); David James Puhl, Indianapolis, IN (US); Clive Grafton-Reed, London (GB); Peter E. Daum, Indianapolis, IN (US); Robert F. Proctor, Indianapolis, IN (US); Christopher Paul Heason, London (GB)

(21) Appl. No.: 18/593,575

(22) Filed: Mar. 1, 2024

(51) Int. Cl. B22F 12/90; B22F 10/28; B22F 10/34; B22F 10/36; B22F 10/85; B22F 12/40; B22F 12/53; B33Y 10/00; B33Y 30/00; B33Y 50/02

(52) U.S. Cl. CPC B22F 12/90; B22F 10/28; B22F 10/34; B22F 10/36; B22F 10/85; B22F 12/40; B22F 12/53; B33Y 10/00; B33Y 30/00; B33Y 50/02; B22F 2203/00; B22F 2998/10

(57) ABSTRACT

An additive manufacturing system may include an energy delivery device configured to deliver energy to a build surface of a component to form a melt pool in the build surface of the component; a powder delivery device configured to direct a powder stream toward the melt pool; a plurality of mass sensors, each mass sensor associated with a portion of the additive manufacturing system; a plurality of heat sensors; and one or more computing devices. The computing device(s) are configured to receive data from the plurality of mass sensors; determine an overall mass flux based on the data from the mass sensors; control the powder delivery device based on the overall mass flux; receive data from the plurality of heat sensors; determine an overall heat flux based on the data from the heat sensors; and control the energy delivery device based on the overall heat flux.

### TECHNICAL FIELD

The disclosure relates to additive manufacturing techniques.

### BACKGROUND

Additive manufacturing generates three-dimensional structures through addition of material layer-by-layer or volume-by-volume to form the structure, rather than removing material from an existing component to generate the three-dimensional structure. Additive manufacturing may be advantageous in many situations, such as rapid prototyping, forming components with complex three-dimensional structures, or the like. In some examples, additive manufacturing may utilize powdered materials and may melt or sinter the powdered material together in predetermined shapes to form the three-dimensional structures.

### SUMMARY

As an example, an additive manufacturing system includes an energy delivery device configured to deliver energy to a build surface of a component to form a melt pool in the build surface of the component; a powder delivery device configured to direct a powder stream toward the melt pool; a plurality of sensors, each mass sensor associated with a portion of the additive manufacturing system; a plurality of heat sensors; and one or more computing devices configured to: receive data from the plurality of mass sensors; determine an overall mass flux based on the data from the plurality of mass sensors; receive data from the plurality of heat sensors; determine an overall heat flux based on the data from the plurality of heat sensors; and input, into one or more machine learning models, the overall mass flux and the overall heat flux; and control, based at least in part on outputs from the one or more machine learning models, the powder delivery device and the energy delivery device.

As another example, a method includes receiving, by one or more computing devices, data from a plurality of mass sensors of an additive manufacturing system, wherein the additive manufacturing system comprises an energy delivery device configured to deliver energy to a build surface of a component to form a melt pool in the build surface of a component, a powder delivery device configured to direct a powder stream toward the melt pool, the plurality of mass sensors, each mass sensor associated with a portion of the additive manufacturing system, and a plurality of heat sensors; determining, by the one or more computing devices, a mass flux based on the data from the plurality of mass sensors; receiving, by the one or more computing devices, data from the plurality of heat sensors; determining, by the one or more computing devices, a heat flux based on the data from the plurality of heat sensors; inputting, by the one or more computing devices and into one or more machine learning models, the overall mass flux and the overall heat flux; and controlling, based at least in part on outputs from the one or more machine learning models, the powder delivery device and the energy delivery device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual block diagram illustrating mass flow monitoring aspects of an example additive manufacturing system that includes a powder source mass sensor, a powder flow monitoring system, and a topology sensor configured to monitor mass flow of powder within the additive manufacturing system during an additive manufacturing technique.

FIG. 2 is a conceptual and schematic diagram illustrating an example powder flow monitoring system configured to monitor powder flow between a powder delivery device and a build surface during the additive manufacturing technique.

FIG. 3 is a conceptual diagram illustrating an example of portions of a powder stream imaged by a powder flow monitoring system.

FIG. 4 is an example calibration curve of particle detections versus mass flow.

FIG. 5 is a conceptual block diagram illustrating heat flow monitoring aspects of the example additive manufacturing system of FIG. 1, including an optical system for observing thermal emissions around a melt pool and a thermal camera for monitoring a size of the melt pool.

FIG. 6 is a conceptual block diagram illustrating an example optical system for observing thermal emissions around a melt pool formed during the additive manufacturing technique.

FIG. 7 is a process flow diagram illustrating a mass flux and heat flux monitoring and control technique.

FIG. 8 is a flowchart illustrating an example technique for fabricating a component with closed loop control.

FIG. 9A is a conceptual diagram illustrating an example machine learning model.

FIG. 9B is a conceptual diagram illustrating an example training process for a machine learning model.

### DETAILED DESCRIPTION

The disclosure generally describes techniques and systems for monitoring mass flux and heat flux in a blown powder additive manufacturing technique, such as a directed energy deposition (DED) technique. During blown powder additive manufacturing, a component is built up by adding material to the component in sequential layers. The final component is composed of a plurality of layers of material. In some blown powder additive manufacturing techniques for forming components from metals or alloys, an energy source may direct energy at a substrate to form a melt pool. A powder delivery device may deliver a powder to the melt pool, where at least some of the powder at least partially melts and is joined to the melt pool and, thus, substrate.

The properties of the final component, including the presence or absence of material defects and the resulting microstructure, are a function of a number of variables related to mass flux and heat flux. As such, measurement of mass flux and heat flux within the blown powder additive manufacturing system may enable characterization or prediction of final component properties, control of the blown powder additive manufacturing technique, quality assurance for the final component, development of new blown powder additive manufacturing techniques, and the like.

An additive manufacturing system may include a plurality of sensors for sensing mass flow at various points along the powder flow and a plurality of sensors for sensing heat flow within the system. For instance, the mass flow sensors may include a mass sensor associated with a powder source, a powder flow monitoring system sensing powder flow between an output of a powder delivery device and the melt pool, and a topology sensor for measuring a topology of material added to the melt pool. The thermal sensors may include at least one sensor for monitoring a size and/or temperature of the melt pool and at least one sensor for monitoring a heat flow (e.g., cooling rate) around the melt pool. The sensors may output data to a computing device, which analyzes the received sensor data. By monitoring mass flow at different points along the powder flow and monitoring heat flow in multiple ways, the system described herein may enable a more complete understanding of mass and heat flux within the system.

Understand the mass and heat flux within the system may give an operator insight into a build in process. The operator may adjust operating parameters (e.g., key process variables (KPVs)) based on the mass flux and/or the heat flux. However, an adage of machine control is to “only turn one knob at a time.” Put differently, it may be undesirable for the operator or other controller to adjust (e.g., alter, modify, etc.) multiple of the operating parameters at once. In particular, adjusting multiple of the operating parameters at the same time may yield unpredictable results. However, only adjusting one of the operating parameters at a time may extend the amount of time it takes the operator or controller to “react” to changes in the build.

In accordance with one or more aspects of this disclosure, an additive manufacturing system may include a controller that executes one or more machine learning models to adjust two or more of the operating parameters in parallel. For instance, the controller may input the determined heat flux and the mass flux into the one or more machine learning models and adjust, based on output of the one or more machine learning models, the two or more of the operating parameters in parallel. In some examples, the two or more operating parameters adjusted by the controller may be non-linearly related to each other. With such a non-linear relationship, it may not be feasible for an operator or traditional controllers to adjust the two or more operating parameters in parallel. However, with the use of the machine learning models, such parallel adjustment of multiple non-linearly related operating parameters may be accomplished. By adjusting two or more operating parameters in parallel, the controller may more quickly “react” to changes in the build.

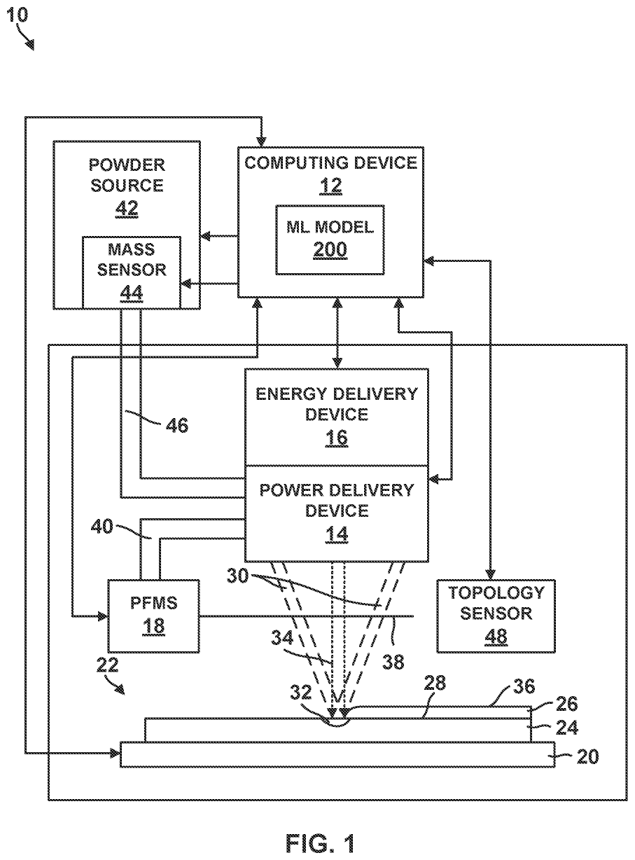

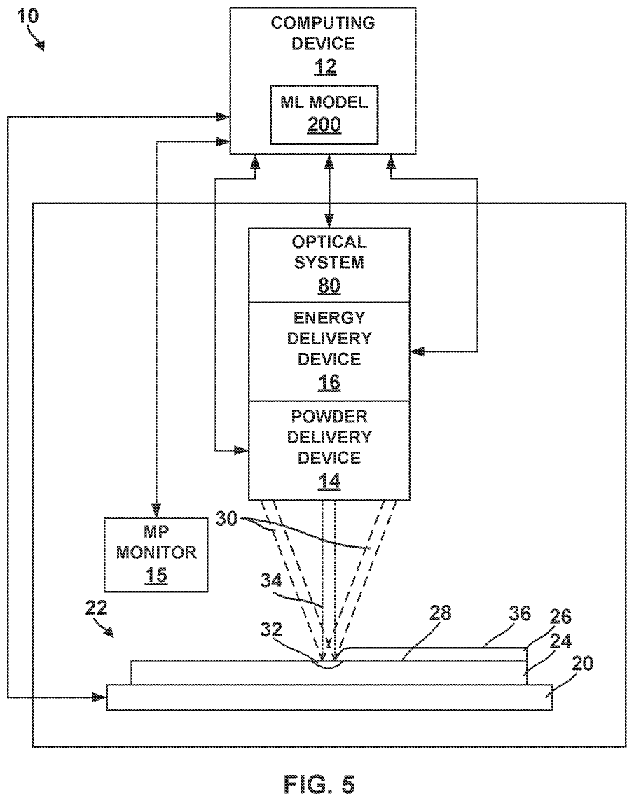

FIG. 1 is a conceptual block diagram illustrating mass flow monitoring aspects of an example additive manufacturing system 10 that includes a powder source mass sensor 44, a powder flow monitoring system 18, and a topology sensor 48 configured to monitor mass flow of powder within additive manufacturing system 10 during an additive manufacturing technique. In the example illustrated in FIG. 1, additive manufacturing system 10 includes a computing device 12, a powder delivery device 14, an energy delivery device 16, PFMS 18, a stage 20, a powder source 42, powder source mass sensor 44, and topology sensor 48. Computing device 12 is operably connected to powder delivery device 14, energy delivery device 16, PFMS 18, stage 20, powder source 42, powder source mass sensor 44, and topology sensor 48. FIG. 1 thus illustrates mass flow monitoring aspects of example additive manufacturing system 10. To simplify illustration of FIG. 1 and improve clarity of the figure, heat flow monitoring aspects of additive manufacturing system 10 are shown in FIG. 5 and described below with reference to FIG. 5.

In some examples, stage 20 is movable relative to energy delivery device 16 and/or energy delivery device 16 is movable relative to stage 20. Similarly, stage 20 may be movable relative to powder delivery device 14 and/or powder delivery device 14 may be movable relative to stage 20. For example, stage 20 may be translatable and/or rotatable along at least one axis to position component 22 relative to energy delivery device 16 and/or powder delivery device 14. Similarly, energy delivery device 16 and/or powder delivery device 14 may be translatable and/or rotatable along at least one axis to position energy delivery device 16 and/or powder delivery device 14, respectively, relative to component 22. Stage 20 may be configured to selectively position and restrain component 22 in place relative to stage 20 during manufacturing of component 22.

Powder source 42 is the source of powder for powder stream 30. Powder source 42 may include any suitable container or enclosure, such as a hopper, configured to hold powder. Powder source 42 also may include mechanism for entraining the powder in a gas flow. For instance, powder source 42 may be coupled to a gas source, which provides a gas flowing through powder source 42 and entraining powder within the gas flow. Additionally, or alternatively, powder source 42 may include an agitator configured to agitate the powder and increase entrainment of the powder in the gas stream.

System 10 may include a powder source mass sensor 44 associated with powder source 42. Powder source mass sensor 44 may be configured to quantify loss of mass in the powder source 42 or, alternatively, a mass flow out of powder source 42.

Powder source 42 is fluidically coupled to powder delivery device 14 via a flow path 46. Flow path 46 may include any suitable structure(s) defining an enclosed flow between powder source 42 and powder delivery device, including conduit, pipe, tubes, or the like. Although not shown in FIG. 1, for at least part of flow path 46 between powder source 42 and nozzles of powder delivery device 14, flow path 46 may split into multiple, parallel sections, e.g., one for each nozzle. Further, although not shown in FIG. 1, in some examples, flow path 46 may include one or more nozzles for controlling flow through flow path 46 as a whole or portions of flow path 46 (e.g., a section associated with a particular nozzle of powder delivery device 14).

Powder delivery device 14 may be configured to deliver powder to selected locations of component 22 being formed via a powder stream 30. Powder delivery device 14 may include one or more nozzles that each output powder. The combined powder defines powder stream 30. In some examples, powder delivery device 14 includes a single nozzle, which may be point nozzle, or a single nozzle that is an annular channel. In other examples, powder delivery device 14 includes a plurality of nozzles (e.g., three nozzles or four nozzles). Regardless of the number of nozzles, powder delivery device 14 may output a powder stream that is focused at a focus plane. As powder delivery device 14 is movable in the z-axis shown in FIG. 1 relative to component 22, the focal plane of powder delivery device 14 also may be movable in the z-axis relative to component 22, such that the focus plane may be controlled to be substantially coincident with build surface 28.

At least some of the powder in powder stream 30 may impact a melt pool 32 in component 22. At least some of the powder that impacts melt pool 32 may be joined to component 22.

In some examples, powder delivery device 14 may be mechanically coupled or attached to energy delivery device 16 to facilitate delivery of powder stream 30 and energy 34 for forming melt pool 32 to substantially the same location adjacent to component 22.

Energy delivery device 16 may include an energy source, such as a laser source, an electron beam source, plasma source, or another source of energy that may be absorbed by component 22 to form a melt pool 32 and/or be absorbed by powder in powder stream 30 to be added to component 22. Example laser sources include a CO laser, a CO₂ laser, a Nd:YAG laser, or the like. In some examples, the energy source may be selected to provide energy with a predetermined wavelength or wavelength spectrum that may be absorbed by component 22 and/or the powder to be added to component 22 during the additive manufacturing technique.

In some examples, energy delivery device 16 also includes an energy delivery head, which is operatively connected to the energy source. The energy delivery head may aim, focus, or direct energy 34 toward predetermined positions at or adjacent to a surface of component 22 during the additive manufacturing technique. As described above, in some examples, the energy delivery head may be movable in at least one dimension (e.g., translatable and/or rotatable) under control of computing device 12 to direct the energy toward a selected location at or adjacent to a surface of component 22.

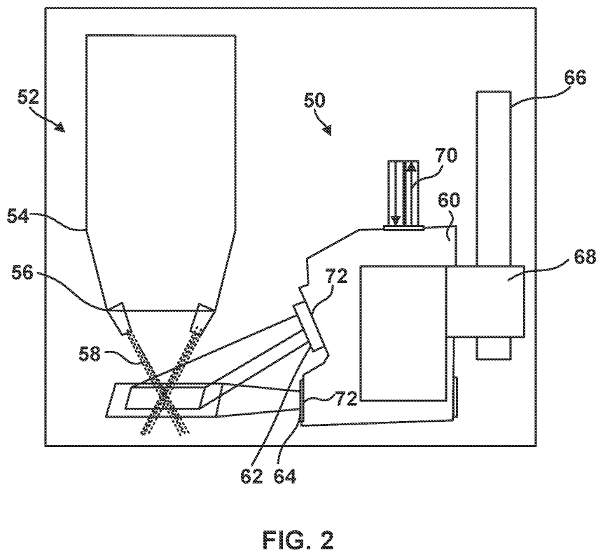

In some examples, at least a portion of energy delivery device 16 and powder delivery device 14 may be combined or attached to each other. For example, a deposition head (e.g., deposition head 54 of FIG. 2) may include part of powder delivery device 14 (e.g., internal channels and powder nozzle(s) 56 for forming powder stream 30 and directing powder stream 30 toward build surface 28) and part of energy delivery device 16 (e.g., the energy delivery head). As shown in FIG. 1, in some examples, energy delivery device 16 may be arranged of configured such that energy 34 and powder stream 30 both exit from a common deposition head and are directed toward build surface 28. For instance, energy 34 may pass through a central channel within the deposition head and exit a central aperture in the deposition head, while fluidized powder may flow through internal channels and powder nozzle(s) 56 for forming powder stream 30 and directing powder stream 30 toward build surface 28.

System 10 also includes powder flow monitoring system (PFMS) 18. PFMS 18 is configured to image at least a portion of powder stream 30 to detect powder flowing between powder delivery device 14 and build surface 28. For example, PFMS 18 may include an illumination device and an imaging device. In some examples, the illumination device may include one or more light source. For instance, the illumination device may include one or more structured light devices, such as one or more lasers. The illumination device is configured to illuminate a plane of powder stream 30 at image plane 38, e.g., a plane substantially perpendicular to an axis extending between powder delivery device 14 and build surface 28.

The imaging device of PFMS 18 is configured to image at least some of the illuminated powder. The imaging device may have a relatively high data acquisition speed (e.g., frame rate), such greater than 1000 Hz. Because of the velocity of the powder in powder stream 30, even such a frame rate may image only a fraction of the powder flowing between powder delivery device 14 and build surface 28.

In some examples, PFMS 18 also includes a housing configured to enclose the illumination device and the imaging device. The housing may be configured to protect the illumination device and the imaging device from damage due to the harsh conditions to which PFMS 18 may be exposed during use. For example, the housing may protect the illumination device and the imaging device from powder deflections from powder stream 30 off build surface 28, may cool the illumination device and the imaging device to remove heat incident on PFMS 18 from melt pool 32 and energy delivery device 16, or the like.

PFMS 18 may be positionally fixed relative to powder delivery device 14 and/or energy delivery device 16, e.g., in the x-y plane shown in FIG. 1. This may help maintain a relative x-y position of PFMS 18 and the image plane of the imaging device relative to powder stream 30. This may facilitate analysis of image data captured by the imaging device.

PFMS 18 may be movable in the z-axis direction of FIG. 1 (e.g., parallel to a longitudinal axis extending from powder delivery device 14 to build surface 28). This may enable movement of image plane 38 along the z-axis of FIG. 1 (e.g., parallel to a longitudinal axis extending from powder delivery device 14 to build surface 28). This may allow PFMS 18 to image powder stream 30 at different positions between powder delivery device 14 and build surface 28. In this way, PFMS 18 may analyze powder stream 30 along powder stream 30 to help determine parameters of powder stream 30 along its length.

In some example, PFMS 18 may be positionally fixed relative to powder delivery device 14 and/or energy delivery device 16 and movable parallel to a longitudinal axis extending from powder delivery device 14 to build surface 28 by an adjustable z-stage 40. Adjustable z-stage 40 may be attached to energy delivery device 16, powder delivery device 14, or a portion of system 10 that moves energy delivery device 16 and/or powder delivery device 14, such that PFMS 18 moves in the x-y axis in registration with energy delivery device 16 and/or powder delivery device 14.

Adjustable z-stage 40 may be controlled by computing device 12 to position PFMS 18 and image plane 38 relative to powder stream 30. Further, computing device 12 may control adjustable z-stage 40 to move PFMS 18 vertically and out of the way to allow powder delivery device 16 and energy delivery device 16 access to physically constrained areas, e.g., between vanes of a doublet or triplet of a nozzle guide vane for a gas turbine engine.

System 10 further includes a topology sensor 48. Topology sensor 48 is configured to monitor an amount of powder captured by melt pool 32 by imaging melt pool 32 and the added material, allowing the mass to be quantified (e.g., by computing device 12) using the dimensions of the added material and density of the material (powder). In some examples, topology sensor 48 includes a laser and a sensor (e.g., an imaging device), which senses laser light reflected by the structure being imaged (e.g., melt pool 32 and the added material). The laser may have a defined wavelength, which may affect the resolution of the topology sensor 48. In some examples, the wavelength and sensor may be selected such that the resolution of topology sensor 48 is a great as about 10 microns (e.g., about 6 microns).

In some examples, topology sensor 48 may be positioned substantially directly above component 22 and may include an interferometer, which provides depth information based on the time from outputting a laser pulse to the sensing of the reflected light. In other examples, topology sensor 48 may be positioned at an offset with respect to component 22 such that the sensor senses depth information without using an interferometer.

In some examples, topology sensor 48 may be integral with system 10, e.g., disposed within the enclosure or working area of system 10. In other examples, topology sensor 48 may be an add-on component to system 10. For example, the enclosure in which the additive manufacturing technique is performed may include a transparent window, and topology sensor 48 may be positioned outside of the enclosure and may image component 22 through the transparent window.

Although a topology sensor 48 is described in the examples of this disclosure, in other examples, another metrology device may be utilized to determine the amount of powder captured by melt pool 32. For example, another type of light source may be used. In some examples, if another type of light source is used, component 22 or stage 20 may include one or more features that serve as indicators of scale.

Computing device 12 is configured to control components of system 10 and may include, for example, a desktop computer, a laptop computer, a workstation, a server, a mainframe, a cloud computing system, or the like. Computing device 12 is configured to control operation of system 10, including, for example, powder delivery device 14, energy delivery device 16, PFMS 18, stage 20, powder source 42, powder source mass sensor 44, and/or topology sensor 48. Computing device 12 may be communicatively coupled to powder delivery device 14, energy delivery device 16, PFMS 18, stage 20, powder source 42, powder source mass sensor 44, and/or topology sensor 48 using respective communication connections. As shown in FIG. 1, computing device 12 may include machine learning model (ML model) 200, which may represent one or more ML models. In some examples, the communication connections may include network links, such as Ethernet, ATM, or other network connections. Such connections may be wireless and/or wired connections. In other examples, the communication connections may include other types of device connections, such as USB, IEEE 1394, or the like.

Although FIG. 1 illustrates a single computing device 12 and attributes all control and processing functions to that single computing device 12, in other examples, system 10 may include multiple computing devices 12, e.g., a plurality of computing devices 12. In general, control and processing functions described herein may be divided among one or more computing devices. For instance, system 10 may include controller for energy delivery device 16, powder delivery device 14, and stage 20, a separate controller for PFMS 18, and a separate computing device for analyzing data obtained by PFMS 18, mass sensor 44, and topology sensor 48. As another example, system may include a dedicated controller for each of energy delivery device 16, powder delivery device 14, stage 20, PFMS 18, and topology sensor 48, and a separate computing device for coordinating control of powder delivery device 14, energy delivery device 16, PFMS 18, stage 20, powder source 42, powder source mass sensor 44, and/or topology sensor 48 and analyzing data obtained by PFMS 18 powder source mass sensor 44, and/or topology sensor 48. Other examples of computing system architectures for controlling system 10 and analyzing data obtained from system 10 will be apparent and are within the scope of this disclosure.

Computing device 12 may be configured to control operation of powder delivery device 14, energy delivery device 16, adjustable z-stage 40, stage 20, and/or topology sensor 48 to position component 22 relative to powder delivery device 14, energy delivery device 16, PFMS 18, and/or topology sensor 48. For example, as described above, computing device 12 may control stage 20 and powder delivery device 14, energy delivery device 16, adjustable z-stage 40 and/or topology sensor to translate and/or rotate along at least one axis to position component 22 relative to powder delivery device 14, energy delivery device 16, PFMS 18, and/or topology sensor 48. Positioning component 22 relative to powder delivery device 14, energy delivery device 16, PFMS 18, and/or topology sensor 48 may include positioning a predetermined surface (e.g., a surface to which material is to be added) of component 22 in a predetermined orientation relative to powder delivery device 14, energy delivery device 16, PFMS 18, and/or topology sensor 48.

Computing device 12 may be configured to control system 10 to deposit layers 24 and 26 to form component 22. As shown in FIG. 1, component 22 may include a first layer 24 and a second layer 26, although many components may be formed of additional layers, such as tens of layers, hundreds of layers, thousands of layers, or the like. Component 22 in FIG. 1 is simplified in geometry and the number of layers compared to many components formed using additive manufacturing techniques. Although techniques are described herein with respect to component 22 including first layer 24 and second layer 26, the technique may be extended to components 22 with more complex geometry and any number of layers.

To form component 22, computing device 12 may control powder delivery device 14 and energy delivery device 16 to form, on a surface 28 of first layer of material 24, a second layer of material 26 using an additive manufacturing technique. Computing device 112 may control energy delivery device 16 and powder delivery device 14 based on one or more operating parameters. In general, the operating parameters may be KPVs that impact the build, such as laser power, travel speed, pause time, dwell time, build strategy, power feed rate, layer thickness, spot size/power density, working distance, etc. Further details of example operating parameters are discussed below. Computing device 12 may control energy delivery device 16 to deliver energy 34 to a volume at or near surface 28 to form melt pool 32. For example, computing device 12 may control the relative position of energy delivery device 16 and stage 20 to direct energy to the volume. Computing device 12 also may control powder delivery device 14 to deliver powder stream 30 to melt pool 32. For example, computing device 12 may control the relative position of powder delivery device 14 and stage 20 to direct powder stream 30 at or on to melt pool 32. Computing device 12 may control powder delivery device 14 and energy delivery device 16 to move energy 34 and powder stream 30 along build surface 28 in a pattern until layer 26 is complete. Computing device 12 then may control a z-axis position of stage 20 and/or powder delivery device 14 and energy delivery device 16 such that melt pool 32 will be formed on surface 36 of second layer 26, and may control powder delivery device 14 and energy delivery device 16 to move energy 34 and powder stream 30 along build surface 28 in a pattern until layer 26 is complete. Computing device 12 may control powder delivery device 14 and energy delivery device 16 similarly until all layers are formed to define a completed component 22.

In accordance with one or more aspects of this disclosure, computing device 12 may utilize ML model 200 to control two or more operating parameters of the plurality of operating parameters in parallel. For instance, computing device 12 may input, to ML model 200, variables determined based on outputs of one or more sensors (e.g., PFMS 18, mass sensor 44, and/or topology sensor 48). ML model 200 may generate outputs based on said inputs. The outputs provided by ML model 200 may include adjusted operating parameters. Computing device 12 may control energy delivery device 16 and powder delivery device 14 based on the updated operating parameters.

FIG. 2 is a conceptual and schematic diagram illustrating an example powder flow monitoring system 50 configured to monitor powder flow between a powder delivery device 52 and a build surface (not shown in FIG. 2) during an additive manufacturing technique. Powder delivery device 52 may be an example of powder delivery device 14 of FIG. 1, and PFMS may be an example of PFMS 18 of FIG. 1. Similar to powder delivery device 14, powder delivery device 52 may be controlled using one or more machine learning models.

Powder delivery device 52 includes a deposition head 54 that carries a plurality of powder nozzles 56. Plurality of powder nozzles 56 output a powder stream 58 toward the build surface. As shown in FIG. 2, the powder stream 58 may be focused at a focal plane, such that powder stream 58 is converging toward the focal plane and diverging away from the focal plane.

PFMS 18 includes a housing 60 (also referred to as an enclosure), which encloses an imaging device 62 and an illumination device 64. In some examples, imaging device 62 may be a high-speed camera and illumination device 64 may be laser illuminator. Housing 60 is attached to an adjustable z-stage 66 by a bracket 68.

Housing 60 is configured to enclose imaging device 62 and illumination device 64 and help protect imaging device 62 and illumination device 64 from a surrounding environment. For instance, housing 60 may be configured to surround imaging device 62 and illumination device 64 and prevent any powder that reflects from the build surface toward PFMS 18 from impacting imaging device 62 or illumination device 64.

Further, housing 60 may be configured to cool imaging device 62 and illumination device 64. Imaging device 62 and illumination device 64 may be exposed to heat from the melt pool at the build surface and energy from the energy delivery device. Imaging device 62 and illumination device 64 may be relatively sensitive to heat and have improved operational lifetime if maintained and operated below a certain temperature. PFMS 50 may include a cooling system 70 configured to remove heat from within housing 60 to cooling imaging device 62 and illumination device 64. For instance, cooling system 70 may include cooling fluid circuit through which a cooling fluid flows, and housing 60 may include part of the cooling circuit. In some examples, housing 60 may be formed from a material having relatively high thermal conductivity, such as aluminum, to help transfer heat from within housing 60 to cooling system 70 (e.g., a cooling fluid flowing through cooling system 70).

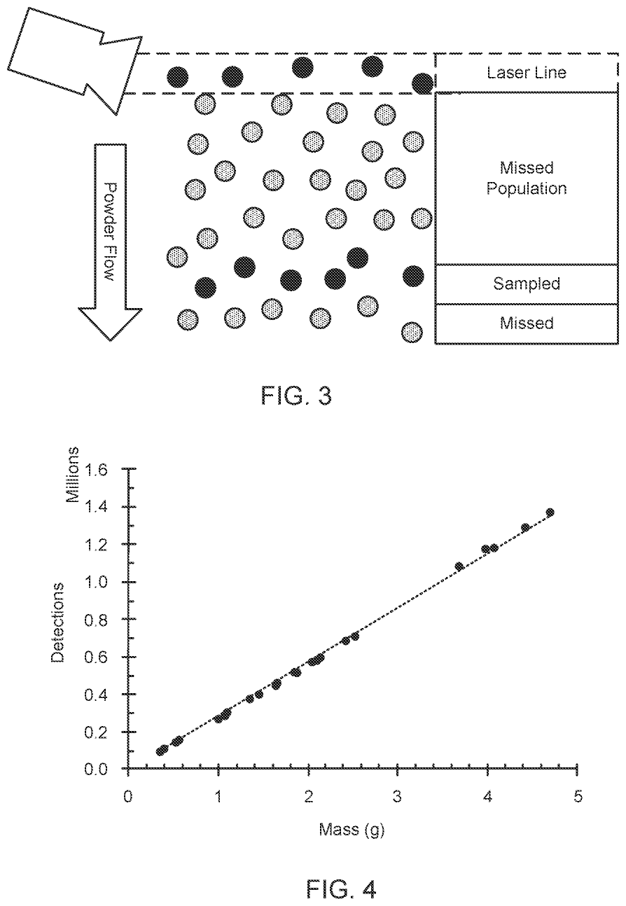

As described above, PFMS 50 may be configured to measure powder flow of powder stream 58 (FIG. 2) at one or more axial (or longitudinal) locations of powder stream 58 and determine one or more parameters associated with the powder flow. For instance, illumination device 64 may illuminate powder of powder stream 58 in a plane oriented substantially orthogonal to a longitudinal axis that extends from powder delivery device 52 to the build surface. PFMS 50 may be positioned at a selected axial or longitudinal location to image a selected axial or longitudinal position between powder delivery device 52 and the build surface. Imaging device 62 may be configured to image at least some of the illuminated powder. FIG. 3 is a conceptual diagram illustrating an example of portions of a powder stream imaged by a powder flow monitoring system.

As shown in FIG. 3, since powder is flowing in powder stream 58 at a relatively high velocity, imaging device 62 may not capture images of all the powder in powder stream 58. The fraction of powder that imaging device 62 captures images of may be a function of average powder velocity at the image plane and a frame rate or capture speed of imaging device 62. This is represented in FIG. 3 as “sampled” particles and “missed population” particles. The fraction of particles imaged by imaging device 62 may, in some examples, be less than about 50%, less than about 40%, less than about 30%, less than about 25%, less than about 20%, or less than about 15%.

PFMS 50 may include a computing device (e.g., computing device 12 of FIG. 1) configured to analyze images captured by imaging device 62 to identify a number of particle detections in each captured image and, optionally, derive further parameters from the number of particle detections. As such, computing device 12 may be configured to receive image data representing an image captured by imaging device 62. The image data may include representations of illuminated powder of powder stream 58, as imaged by imaging device 62 (e.g., as captured in an image frame by imaging device 62). Computing device 12 may be configured to generate a representation of powder stream based on the image data and output the representation of the powder stream for display at a display device.

For instance, computing device 12 may be configured determine a powder mass flow represented by the image data. To do so, computing device 12 may be configured to identify a number of powder particles within each image frame. In some examples, computing device 12 additionally may be configured to identify a size and/or shape of each powder particle within each image frame. Computing device 12 may be configured to implement any suitable image analysis technique to identify powder particles, and, optionally, size and/or shape of powder particles.

Once computing device 12 has identified a number of powder particles within an image frame, computing device 12 may be configured to determine a mass flow based on the number of powder particles. For example, computing device 12 may be configured to determine the mass flow based on a calibration equation or calibration curve. FIG. 5 is an example calibration curve of particle detections versus mass flow. As shown in FIG. 4, the relationship between particle detections may be substantially linear.

The relationship between particle detections and mass flow may be determined experimentally. For instance, the relationship between particle detections and mass flow may be determined for each powder type (e.g., composition, size distribution, or both), as each powder type may have a different relationship between particle detections and mass flow. The relationship may be determined experimentally by flowing a known mass of powder at a known rate, and imaging the powder. By doing this multiple times at multiple rates, the calibration curve may be generated. The curve, in the form of an equation, a look-up table, or the like, may be stored in computing device 12, and computing device 12 may use the calibration curve to determine mass flow of a similar type of powder at a different flow rate based on particle detections.

In some examples, computing device 12 may receive image data representative of a sequence of images of illuminated powder in powder stream 58. Each image may be associated with a time. As such, computing device 12 may select one or more images of the sequence of images and analyze the one or more images. For each selected image, computing device 12 may be configured to identify a number of particle detections and, optionally, determine a mass flow associated with powder stream 58 for each image frame.

As described above, system 10 may include both mass flow monitoring and heat flow monitoring, but FIG. 1 illustrates only mass flow monitoring aspects of system 10. FIG. 5 is a conceptual block diagram illustrating heat flow monitoring aspects of the example additive manufacturing system 10 of FIG. 1, including an optical system 80 for observing thermal emissions around melt pool 32 and a thermal camera 82 (e.g., pool monitor) for monitoring a size and/or temperature of melt pool 32. Identical reference numerals in FIGS. 1 and 5 refer to the same parts. Further, those common parts are the same or substantially identical, aside from any differences described herein.

As shown in FIG. 5, system 10 includes an optical system 80. During additive manufacturing, component 22 is built up by adding material to component 22 in sequential layers. The final component is composed of a plurality of layers of material. Energy delivery device 16 may direct energy 34 at first layer 24 to form melt pool 32. Powder delivery device 14 may deliver powder stream 30 to melt pool 32, where at least some of the powder at least partially melts and is joined to first layer 24. Melt pool 32 cools as energy 34 is no longer delivered to that location of first layer 24 (e.g., due to energy delivery device 16 scanning energy 34 over the surface of first layer 24). The temperature and cooling rate of melt pool 32 and the surrounding areas of first layer 24 affect the microstructure of the component 22 formed using the additive manufacturing technique.

In many cases, energy 34 output by energy delivery device 16 is very high temperature and the intensity of its thermal emissions is significantly greater than the intensity of thermal emissions from melt pool 32 and the surrounding areas. Similarly, thermal emissions intensity at and near the center of melt pool 32 may be significantly greater than the intensity of thermal emissions near the edge of melt pool 32 and in areas surrounding melt pool 32. Because of this, it may be difficult to accurately measure temperature and cooling rate of areas near the edge of melt pool 32 and in areas surrounding melt pool 32. This results in difficulty predicting and controlling microstructure of the additively manufactured component 22.

Optical system 80 may include an imaging device and an associated optical train, which senses emissions at or near component 22 during the additive manufacturing technique. For example, optical system 80 may include a visible light imaging device, an infrared imaging device, or an imaging device that is configured (e.g., using a filter) to image a specific wavelength or wavelength range.

The optical train may include one or more reflective, refractive, diffractive optical components configured to direct light to the imaging device. For example, the optical train may be configured to direct light from near component 22 and/or melt pool 32 to the imaging device. In some examples, at least a portion of the optical train is coaxial with the axis at which energy delivery device 16 outputs energy, and the at least a portion of the optical train may be attached to or otherwise configured to move with the portion of energy delivery device 16 that directs or focuses energy 34 at or near the surface of component 22. In this way, optical system 80 may move with energy delivery device 16 and track melt pool 32 as melt pool 32 moves across component 22, without needing to correct for any offsets between energy delivery device 16 and optical system 80 and/or needing to correct for geometry of component 22. In other examples, the optical train may not be coaxial with the axis at which energy delivery device 16 outputs energy 34, and computing device 12 may be configured to compensate for the offset and any affects this may have on the imaging, including shadowing, interference, geometry of component 22, or the like.

Optical system 80 may include an occulting device. The occulting device is configured to reduce or block emissions (e.g., thermal emissions) that originate from the energy output by energy delivery device 16 and/or near a center of melt pool 32, which otherwise obfuscate emissions from solidifying regions of material at or near the edge of melt pool 32 and outside of melt pool 32. The occulting device may be a rigid occulting device or a dynamic occulting device. A rigid occulting device reduces or blocks emissions from a fixed region, e.g., from the energy 34 output by energy delivery device 16. For instance, a rigid occulting device may include a device with fixed dimensions that is opaque to wavelengths of interest. As another example, a rigid occulting device may include an apodizing lens in which a center of the lens if substantially opaque to wavelengths of interest and opacity decreases as a function of radius.

A dynamic occulting device is configured to be controlled to occult different regions, e.g., different sizes and/or shapes. A dynamic occulting device may include a rigid occulting device that is mounted to a device that can translate the rigid occulting device along and/or perpendicularly to the optical axis. As another example, a dynamic occulting device may include an opaque and viscous liquid, such as mercury, contained between two substrates. The substrates are substantially transparent to the wavelength(s) of interest. One or both of the substrates may be movable relative to the other substrate to control the distance between the substrates. By reducing the distance between the substrates, the size of the occulting region may increase. By increasing the distance between the substrates, the size of the occulting region may decrease. As a third example, a dynamic occulting device may include a digital micromirror device. Computing device 12 may be configured to control the micromirrors of the digital micromirror device to direct emissions that originate from energy 34 output by energy delivery device 16 and/or near a center of the melt pool away from the imaging device. A digital micromirror device may enable control of both the size and shape of the region of emissions that are occulted.

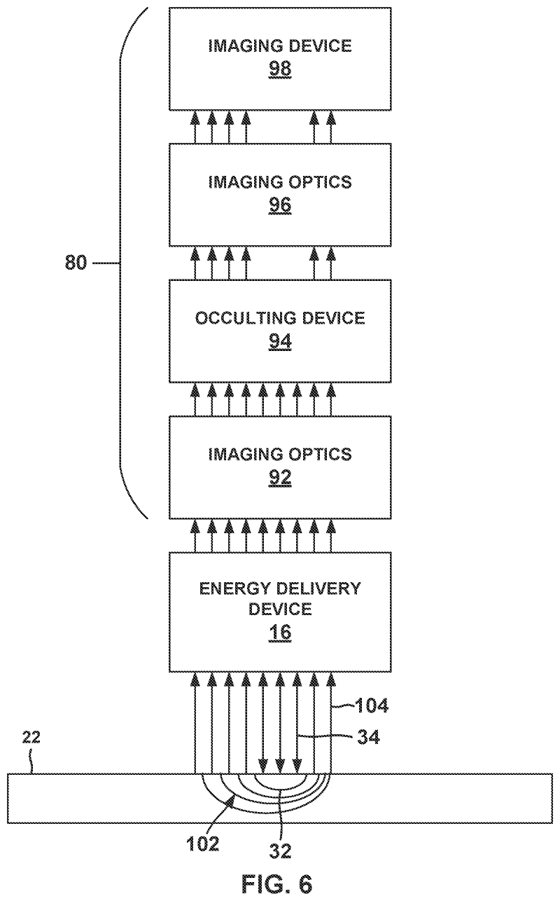

FIG. 6 is a conceptual block diagram illustrating an example optical system 80 for observing thermal emissions at and/or around a melt pool 32 formed during an additive manufacturing technique. Optical system 80 includes an optical train that includes first imaging optics 92, occulting device 94, second imaging optics 96, and imaging device 98. Imaging device 98 may be any suitable imaging device, including, for example, a visible light imaging device, an infrared imaging device, an imaging device that is configured (e.g., using a filter) to image a specific wavelength or wavelength range, a two color pyrometry imaging device, or the like.

First and second imaging optics 92 and 96 may each include one or more optical devices used to direct light to imaging device 98. For example, First and second imaging optics 92 and 96 may each include one or more refractive optical device (e.g., a lens), one or more reflective optical device (e.g., a mirror), one or more diffractive optical devices (e.g., a grating), one or more dichroic optical devices (e.g., a dichroic filter or mirror), or the like. Although two sets of imaging optics 92 and 98 are shown in FIG. 2, in other examples, system 80 may include a single set of imaging optics or more than two sets of imaging optics.

Occulting device 94 is positioned within the optical train between first imaging optics 92 and second imaging optics 96. In other example, occulting device 94 may be positioned between imaging device 98 and imaging optics 96 or after before imaging optics 92. In some examples, occulting device 94 is positioned as the optical component nearest imaging device. This effectively results in removal of the portion of the image which occulting device 94 blocks. In other examples, occulting device 94 is positioned at another position within the optical train 80 where the image of component 22 resolves. Imaging optics 96 then may be configured to image occulting device 94 onto imaging device 98.

As shown in FIG. 6, in some examples, at least a portion of optical system 80 is coaxial with the axis at which energy delivery device 16 outputs energy 34. For example, at least a portion of second imaging optics 92 (e.g., the portion at which emitted light 104 is incident upon second imaging optics 92) may be coaxial with the axis at which energy delivery device 16 outputs energy 34. This may reduce image manipulation that otherwise may be applied to the resulting image to correct for geometry of component 22, angular offset of optical system 80 relative to energy delivery device 16, shadowing due to the angular offset, interference, or the like. In other examples, optical system 80 (e.g., the portion at which emitted light 104 is incident upon second imaging optics 92) may not be coaxial with the axis at which energy delivery device 16 outputs energy 34, and computing device 12 (FIG. 1) or another computing device may be configured to manipulate the resulting image to compensate for geometry of component 22, angular offset of optical system 80 relative to energy delivery device 16, shadowing due to the angular offset, interference, or the like.

FIG. 6 also illustrates energy delivery device 16 outputting energy 34, which is incident upon component 22 and results in formation of melt pool 32. Surrounding melt pool is a cooling zone 102, in which temperature gradients from the temperature of melt pool 32 to ambient temperature are present. As shown in FIG. 6, melt pool 32 and cooling zone 102 emit thermal emissions 104 (e.g., thermal radiation), which travel through optical system 80 to imaging device 98, which images the thermal emissions 104. Occulting device 94 occults (e.g., reduces the intensity of or substantially eliminates) thermal emissions 104 from a selected region, e.g., a region corresponding to energy 34 and at least a portion of melt pool 32. This may allow imaging device 98 to more effectively image relatively lower intensity thermal emissions from at or near the edge of melt pool 32 and within cooling zone 102. This may enable more accurate measurement of temperatures within the cooling zone 102, and heat flow within cooling zone 102.

Returning to FIG. 5, system 10 also includes melt pool monitor (“MP monitor”) 82. Melt pool monitor 82 may include a sensor for monitoring a characteristic of melt pool 32. The sensor may include an imaging system, such as a visual or thermal camera, e.g., camera to visible light or infrared (IR) radiation. A visible light camera may monitor the geometry of the melt pool, e.g., a width, diameter, shape, or the like. A thermal (or IR) camera may be used to detect the size, temperature, or both of the melt pool. In some examples, a thermal camera may be used to detect the temperature of the melt pool at multiple positions within the melt pool, such as a leading edge, a center, and a trailing edge of the melt pool. In some examples, the imaging system may include a relatively high speed camera capable of capturing image data at a rate of tens or hundreds of frames per second or more, which may facilitate real-time detection of the characteristic of the melt pool.

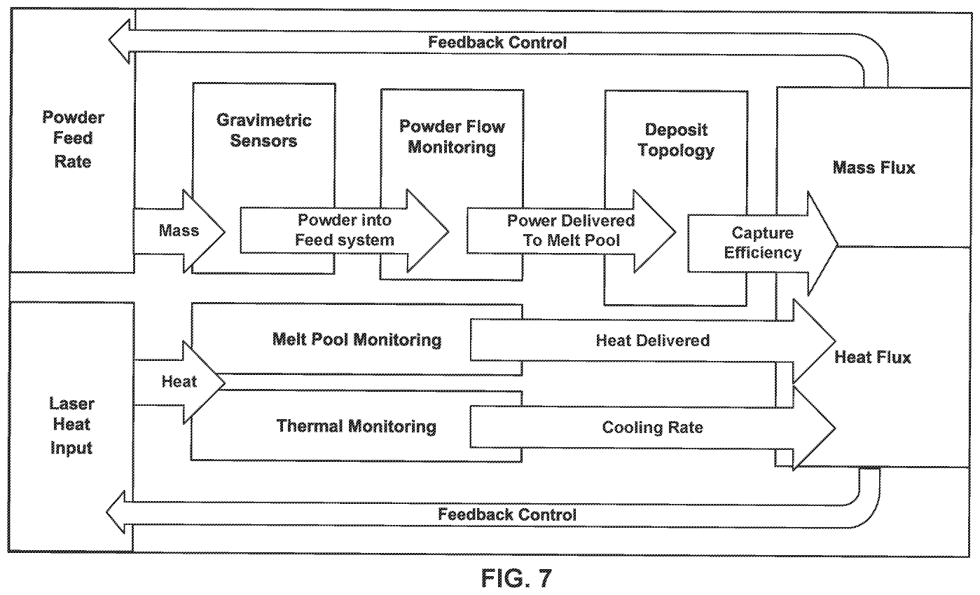

FIG. 7 is a process flow diagram illustrating a mass flux and heat flux monitoring and control technique. The technique of FIG. 7 may be implemented by system 10 of FIGS. 1 and 5 and will be described with concurrent reference to FIGS. 1 and 5. However, it will be appreciated that system 10 may perform other techniques and the technique of FIG. 7 may be performed by other systems.

One or more computing devices 12 may be configured to control a powder feed rate output by powder source 42 (see top left of FIG. 7). For instance, one or more computing devices 12 may be configured to control an agitator of powder source 42, a gas flow rate of gas flowing through powder source 42, a position of one or more valves within flow path 46, or the like to control a powder feed rate output by powder source 42. Such parameters may be referred to as powder delivery device operating parameters.

One or more computing devices 12 may be configured to receive data from one or more mass flow monitoring sensors, including PFMS 18, powder flow mass sensor 44, and/or topology sensor 48. Data received from powder flow mass sensor 44 indicates a mass flow of powder from powder source 42 to powder delivery device. Data from PFMS 18 indicates a mass flow of powder in powder stream 30 between powder delivery device 14 to adjacent melt pool 32. Data from topology sensor 48 indicates powder mass captured by melt pool 32 and added to component 22.

One or more computing devices 12 may calculate one or more mass flow-related metrics based on the data received from PFMS 18, powder flow mass sensor 44, and/or topology sensor 48. For example, one or more computing devices 12 may determine a capture efficiency by determining a fraction or percentage of powder from powder stream 30 that is captured by melt pool 32 and added to component 22, e.g., by dividing the powder mass captured by melt pool 32, as determined based on data from topology sensor, into the mass flow determined based on data received from PFMS 18.

Further, one or more computing devices 12 may determine an overall mass flux using the data received from PFMS 18, powder flow mass sensor 44, and/or topology sensor 48. One or more computing devices 12 then may use the overall mass flux as an input to the control algorithm used to control the powder feed rate output by powder source 42 (see top left of FIG. 7).

Similarly, one or more computing devices 12 may be configured to control energy delivery device 16 to deliver energy 34 to first layer 24 to establish a given heat input (see bottom left of FIG. 7). For example, one or more computing device 12 may control one or more optical parameters of energy delivery device 16, such as intensity, pulse rate, pulse width, or the like; one or more positional parameters related to energy delivery device 16, such as dwell time at a location, a movement rate relative to first layer 24, an overlap between adjacent passes of energy 34 across first layer 24, a pause time between adjacent passes of energy 34 across first layer 24, or the like to control heat input to system 10 (e.g., to melt pool 32 and component 22). The one or more optical parameters and the one or more positional parameters related to energy delivery device may be collectively referred to as one or more energy delivery device operating parameters. As such, the one or more energy delivery device operating parameters may include one or more of intensity, pulse rate, pulse width, dwell time at a location, a movement rate relative to first layer 24, an overlap between adjacent passes of energy 34 across first layer 24, a pause time between adjacent passes of energy 34 across first layer 24, or the like to control heat input to system 10 (e.g., to melt pool 32 and component 22).

One or more computing devices 12 may be configured to receive from one or more heat sensors, such as optical system 80 and/or melt pool monitor 82. One or more computing devices may determine a cooling rate and associated heat from using data from optical system 80 and may determine a heat input into component using a size and/or temperature of melt pool 32 as observed by melt pool monitor. One or more computing devices 12 may be configured to determine an overall heat flux using these data. One or more computing devices 12 then may use the overall heat flux as an input to the control algorithm used to control the energy delivery by energy delivery device 16 (see top left of FIG. 7).

In some examples, one or more computing devices 12 also may use the deposit topology (captured powder mass) and/or capture efficiency metric in the determination of the heat flux, as the added powder mass and quench effects associated with the captured powder affect the cooling rate.

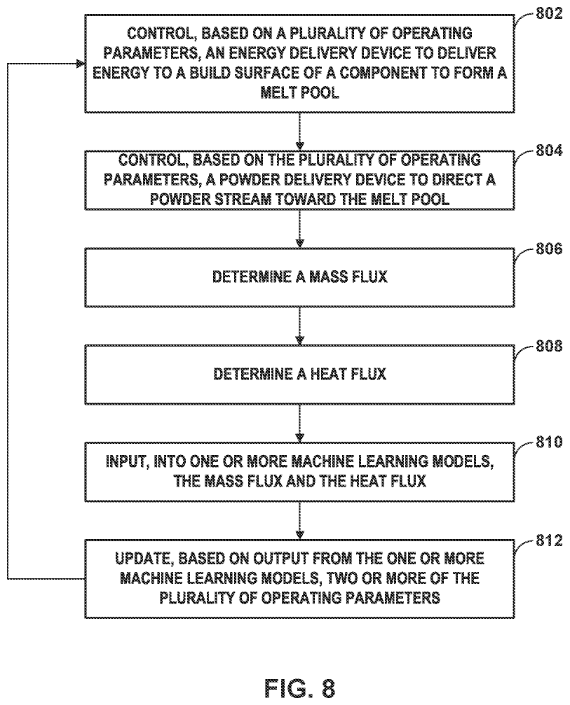

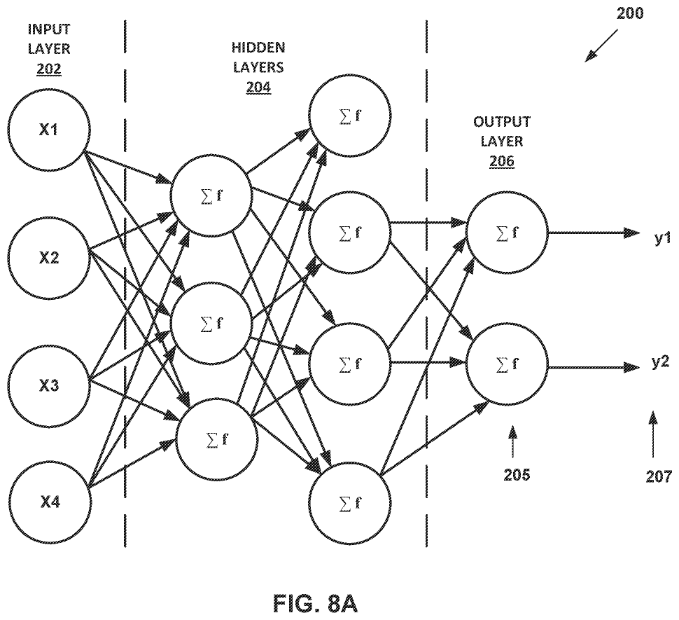

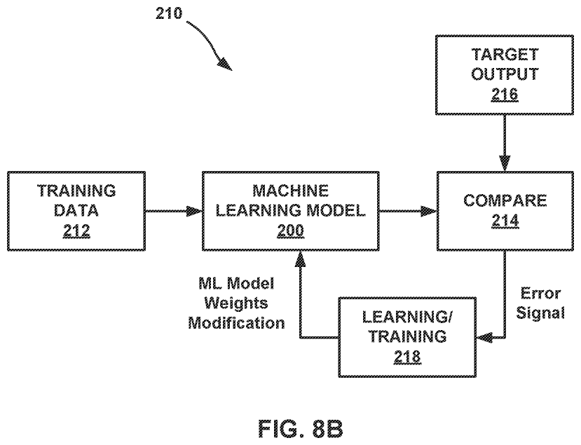

FIG. 8 is a flow diagram illustrating an example technique for closed loop control of an additive manufacturing system, in accordance with one or more aspects of this disclosure. The technique of FIG. 8 may be performed by one or more processors of a computing device, such as computing device 12 of FIG. 1 of FIG. 5.

Computing device 12 may control, based on a plurality of operating parameters, an energy delivery device to delivery energy to a build surface of a component to form a melt pool (802). For instance, computing device 12 may control energy delivery device 16 to operate in accordance with one or more energy delivery device operating parameters. As discussed above, the energy delivery device operating parameters may include one or more of an intensity, a pulse rate, a pulse width, a dwell time at a location, a movement rate, an overlap between adjacent passes, and/or a pause time between adjacent passes.

Computing device 12 may control, based on the plurality of operating parameters, a powder delivery device to direct a powder stream toward the melt pool (804). For instance, computing device 12 may control powder delivery device 14 to operate in accordance with one or more powder delivery device operating parameters. As discussed above, the powder delivery device operating parameters may include one or more of a speed of an agitator of a powder source, a gas flow rate of gas flowing through the powder source, a position of one or more valves within a flow path, or the like to control a powder feed rate output by the powder source.

Computing device 12 may determine a mass flux (806). For instance, as discussed above with reference to FIG. 7, computing device 12 may determine the mass flux using the data received from PFMS 18, powder flow mass sensor 44, and/or topology sensor 48.

Computing device 12 may determine a heat flux (808). For instance, as discussed above with reference to FIG. 7, computing device 12 may determine the heat flux using the data received from the one or more heat sensors, such as optical system 80 and/or melt pool monitor 82.

Computing device 12 may input, into one or more machine learning models, the mass flux and the heat flux (810). For instance, computing device 12 may input the mass flux and/or the heat flux into an input layer (e.g., input layer 202) of ML model 200. In some examples, computing device 12 may, in addition to or in place of the mass flux and/or heat flux, input the measurements from which the mass and heat flux were calculated into the input layer of ML model 200. As such, in some examples, computing device 12 may omit intermediate calculation of the mass and/or heat flux.

In some examples, the machine learning model(s) used (e.g., ML model 200) may be generic ML models for additive manufacturing. However, when manufacturing certain complex components (e.g., members of gas-turbine engines), such generic models may not produce optimal results. In accordance with one or more aspects of this disclosure, in some examples, computing device 12 may use machine learning models that are specific to the type of component being built. For instance, ML model 200 may be trained on components of a same type as the component being built.

Computing device 12 may update, based on output from the one or more machine learning models, two or more of the plurality of operating parameters (812). For instance, computing device 12 may update two of more of the plurality of operating parameters based on an output (e.g., output 207) of ML model 200. In some examples, the output of ML model 200 may include an output for each of the operating parameters controlled by computing device 12. With each iteration of this technique, some of the operating parameters may be changed (e.g., have new values) while some of the operating parameters may not be changed (e.g., have the same values). Computing device 12 may then control the energy delivery device (802) and the powder delivery device (804) based on the updated operating parameters.

As discussed above, in some examples, the two or more operating parameters updated by computing device 12, in parallel, may have a non-linear relationship. For instance, adjusting the delivered energy may have a non-linear relationship to either powder delivery feed rate or to travel speeds needed to compensate for the change in delivered energy (e.g., to control the melt pool size or powder capture rate). As discussed above, adjusting multiple parameters, especially non-linear parameters, in parallel may be taught away from as undesirable. However, by utilizing one or more machine learning models as described herein, multiple parameters may be successfully adjusted in parallel.

Computing device 12 may perform the operating parameter update at regular intervals. As one example, computing device 12 may perform the operating parameter update at temporal intervals (e.g., every 5 seconds, 10 seconds, 1 minutes, 5 minutes, etc.). As another example, computing device 12 may perform the operating parameter update at build intervals (e.g., every layer, every second layer, etc.). By adjusting two or more operating parameters in parallel, the controller may more quickly “react” to changes in the build.

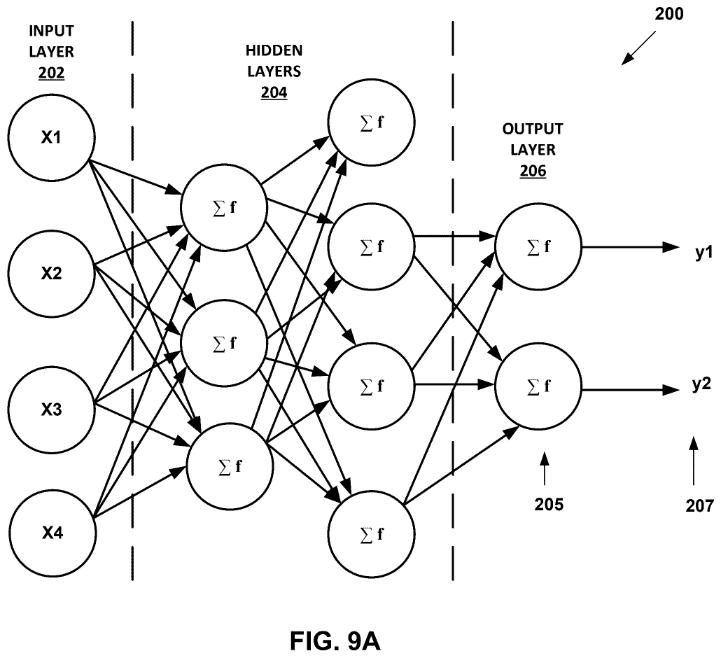

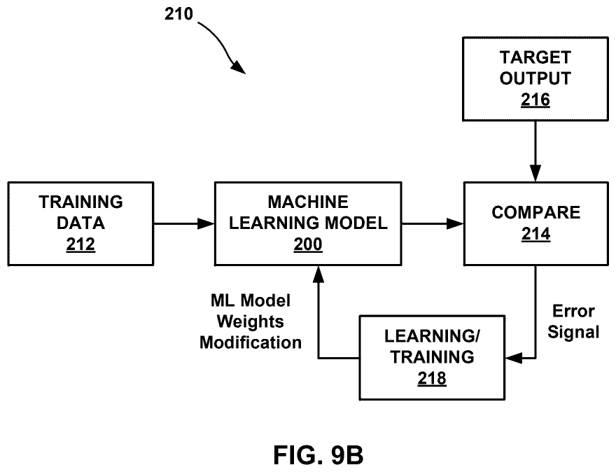

As explained above, additive manufacturing systems described herein may be configured to use machine learning processes for evaluating sensor data to adjust operating parameters for subsequent deposition. FIG. 9A is a conceptual diagram illustrating an example machine learning model according to one or more aspects of this disclosure. Machine learning model 200 may be an example of a machine learning model implemented by computing device 12. Machine learning model 200 may be an example of a deep learning model, or deep learning algorithm, trained to determine deposition parameters for subsequent layers. Computing device 12 and/or another device, may train, store, and/or utilize machine learning model 200, but other devices of system 10 may apply inputs to machine learning model 200. In some examples, other types of machine learning and deep learning models or algorithms may be utilized. For example, a convolutional neural network model of ResNet-18 may be used. Some non-limiting examples of models that may be used for transfer learning include AlexNet, VGGNet, GoogleNet, ResNet50, or DenseNet, etc. Some non-limiting examples of machine learning techniques include Support Vector Machines, K-Nearest Neighbor algorithm, and Multi-layer Perceptron.

As shown in the example of FIG. 9A, machine learning model 200 may include three types of layers. These three types of layers include input layer 202, hidden layers 204, and output layer 206. Output layer 206 includes the output from the transfer function 205 of output layer 206. Input layer 202 represents each of the input values X1 through X4 provided to machine learning model 200. In some examples, the input values may include any of the values input into the machine learning model, as described above. For example, the input values may include sensor data from sensor 48, or other data received by computing device 12, as described above. In some examples, the input values may be determined heat flux, determined mass flux, or values used to determine the mass flux or the heat flux. In addition, in some examples input values of machine learning model 200 may include additional data, such as other data that may be collected by or stored in system 10.

Each of the input values for each node in the input layer 202 is provided to each node of a first layer of hidden layers 204. In the example of FIG. 5A, hidden layers 204 include two layers, one layer having four nodes and the other layer having three nodes, but fewer or greater number of nodes may be used in other examples. Each input from input layer 202 is multiplied by a weight and then summed at each node of hidden layers 204. During training of machine learning model 200, the weights for each input are adjusted to establish a relationship between topological data and deposition parameters that generate the layer represented by the topological data. In some examples, one hidden layer may be incorporated into machine learning model 200, or three or more hidden layers may be incorporated into machine learning model 200, where each layer includes the same or different number of nodes.

The result of each node within hidden layers 204 is applied to the transfer function of output layer 206. The transfer function may be linear or non-linear, depending on the number of layers within machine learning model 200. Example non-linear transfer functions may be a sigmoid function or a rectifier function. The output 207 of the transfer function may be a set of updated operating parameters.

FIG. 9B is a conceptual diagram illustrating an example training process for a machine learning model according to one or more aspects of this disclosure. Process 210 may be used to train machine learning model 200. Machine learning model 200 may be implemented using any number of models for supervised and/or reinforcement learning, such as but not limited to, an artificial neural network, a decision tree, naïve Bayes network, support vector machine, or k-nearest neighbor model, CNN, RNN, LSTM, ensemble network, to name only a few examples.

In some examples, computing device 12 or another device trains machine learning model 100 based on a corpus of training data 212. Training data 212 may include, for example, previous topological data of a build over time, previous operating parameter data, and/or the like. Previous operating parameter data, for example, may include operating parameters associated with previous additive manufacturing processes. In some examples, the sensor data and/or operating parameter data may be generated by executing a natural language processing application on content of a plurality of operational records to automatically extract relevant nor desired training data. For example, by using an NLP model, computing device 12 may capture potentially cofounding operation conditions or factors, which may be useful in determining a set of operating parameters. Computing device 12 may use the NLP model to capture such details.

In some examples, training data 212 may include annotations identifying effects of operating parameters indicated in topological data of training data 212. Training data 212 may include data from past additive deposition processes performed on components having different geometries, formed from different materials, formed under different conditions, and/or the like.

While training machine learning model 200, computing device 12 may compare 214 a prediction or classification with a target output 216. Computing device 12 may utilize an error signal from the comparison to train (learning/training 218) machine learning model 200. Computing device 12 may generate machine learning model weights or other modifications which computing device 12 may use to modify machine learning model 200. For example, computing device 12 may modify the weights of machine learning model 200 based on the learning/training 218.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. An additive manufacturing system comprising:
an energy delivery device configured to deliver energy to a build surface of a component to form a melt pool in the build surface of the component;
a powder delivery device configured to direct a powder stream toward the melt pool;
a plurality of sensors, each mass sensor associated with a portion of the additive manufacturing system;
a plurality of heat sensors; and
one or more computing devices configured to:
receive data from the plurality of mass sensors;
determine an overall mass flux based on the data from the plurality of mass sensors;
receive data from the plurality of heat sensors;
determine an overall heat flux based on the data from the plurality of heat sensors; and
input, into one or more machine learning models, the overall mass flux and the overall heat flux; and
control, based at least in part on outputs from the one or more machine learning models, the powder delivery device and the energy delivery device.

2. The additive manufacturing system of claim 1, wherein, to control the powder delivery device and the energy delivery device, the one or more computing devices are configured to:
control a plurality of operating parameters of the powder delivery device and the energy delivery device.

3. The additive manufacturing system of claim 2, wherein, to control the plurality of operating parameters, the one or more computing devices are configured to:
adjust, in parallel, two or more operating parameters of the plurality of operating parameters.

4. The additive manufacturing system of claim 3, wherein the two or more operating parameters have a non-linear impact on building of the component.

5. The additive manufacturing system of claim 2, wherein the plurality of operating parameters includes one or more powder delivery device operating parameters and one or more energy delivery device operating parameters.

6. The additive manufacturing system of claim 5, wherein:
the one or more powder delivery device operating parameters include one or more of a powder feed rate, a gas flow rate, and an agitator rate, and
the one or more energy delivery device operating parameters include one or more of power, travel speed, pause time, dwell time, working distance, and spot size.

7. The additive manufacturing system of claim 1, wherein the one or more computing devices are further configured to update one or both of a layer thickness and build strategy of the component based at least in part on the outputs from the one or more machine learning models.

8. The additive manufacturing system of claim 1, wherein the one or more machine learning models are trained on components of a same type as the component.

9. The additive manufacturing system of claim 8, wherein the one or more computing devices are further configured to:
update, based on the build of the component, the one or more machine learning models.

10. The additive manufacturing system of claim 8, wherein the component is a member of a gas-turbine engine.

11. A method comprising:
receiving, by one or more computing devices, data from a plurality of mass sensors of an additive manufacturing system, wherein the additive manufacturing system comprises an energy delivery device configured to deliver energy to a build surface of a component to form a melt pool in the build surface of a component, a powder delivery device configured to direct a powder stream toward the melt pool, the plurality of mass sensors, each mass sensor associated with a portion of the additive manufacturing system, and a plurality of heat sensors;
determining, by the one or more computing devices, a mass flux based on the data from the plurality of mass sensors;
receiving, by the one or more computing devices, data from the plurality of heat sensors;
determining, by the one or more computing devices, a heat flux based on the data from the plurality of heat sensors;
inputting, by the one or more computing devices and into one or more machine learning models, the mass flux and the heat flux; and
controlling, based at least in part on outputs from the one or more machine learning models, the powder delivery device and the energy delivery device.

12. The method of claim 11, wherein controlling the powder delivery device and the energy delivery device comprises:
controlling a plurality of operating parameters of the powder delivery device and the energy delivery device.

13. The method of claim 12, wherein controlling the plurality of operating parameters comprises:
adjusting, in parallel, two or more operating parameters of the plurality of operating parameters.

14. The method of claim 13, wherein the two or more operating parameters have a non-linear impact on building of the component.

15. The method of claim 12, wherein the plurality of operating parameters includes one or more powder delivery device operating parameters and one or more energy delivery device operating parameters.

16. The method of claim 15, wherein:
the one or more powder delivery device operating parameters include one or more of a powder feed rate, a gas flow rate, and an agitator rate, and
the one or more energy delivery device operating parameters include one or more of power, travel speed, pause time, dwell time, working distance, and spot size.

17. The method of claim 11, further comprising updating one or both of a layer thickness and build strategy of the component based at least in part on the outputs from the one or more machine learning models.

18. The method of claim 11, wherein the one or more machine learning models are trained on components of a same type as the component.

19. The method of claim 18, further comprising:
updating, based on the build of the component, the one or more machine learning models.

20. The method of claim 18, wherein the component is a member of a gas-turbine engine.
